(19) United States
(12) Patent Application Publication
(10) Pub. No.: US 2026/0178305 A1
(43) Pub. Date: Jun. 25, 2026

(54) SYSTEM AND METHOD FOR FIRMWARE UPDATE

(71) Applicant: Aivres Systems Inc., San Jose, CA (US)

(72) Inventor: Chao Yang CHENG, New Taipei City (TW)

(21) Appl. No.: 18/990,917

(22) Filed: Dec. 20, 2024

(51) Int. Cl. G06F 8/65; G06F 9/445; G06F 11/14; G06F 40/205

(52) U.S. Cl. CPC G06F 8/65; G06F 9/44505; G06F 11/1446; G06F 40/205

(57) ABSTRACT

Systems and methods for system update are provided. In some embodiments, a method comprises generating a configuration backup corresponding to configurations of first firmware that is currently running on a system; updating the system from the first firmware to second firmware; configuring the second firmware based on the configuration backup; and operating the system using the second firmware. The configuration backup may be stored in first memory space. The system may check the first memory space to determine the existence of the configuration backup.

### COPYRIGHT NOTICE

A portion of the disclosure in this patent document contains material which is subject to copyright protection. The copyright owner has no objection to the facsimile reproduction by anyone of the patent document or the patent disclosure, as it appears in the Patent and Trademark Office's patent file or records, but otherwise reserves all copyright rights whatsoever.

### TECHNICAL FIELD

The disclosed embodiments relate generally to computer systems, and more particularly, to the control and management of the systems' operation.

### BACKGROUND

Computer systems, such as servers, may include a controller, such as a baseboard management controller (BMC), to perform various management task, such as hardware control, monitoring, and system management, either independently or in cooperation with the system's main processors.

A firmware solution provides logic and features that enable the controller to manage and maintain the system effectively, often independently of the main processors and an operating system (OS). Various firmware solutions are available for computer systems, such as the Automated Mainframe Intelligence (AMI) BMC solution and the OpenBMC solution. Each solution offers distinct features and functionalities that can affect the protocols used, compatibility with OS drivers, security, and the range of management features available. For example, AMI BMC firmware includes prepackaged features and proprietary optimizations, while OpenBMC provides a more flexible and open platform. These differences influence the overall integration and functionality between the controller and the OS.

Depending on customer requirements, different firmware solutions may be selected for server products. In some cases, a customized firmware solution or ability to switch between different firmware solutions may be appropriate. Such solutions may involve adopting different formats and information structures. Conventionally, such solutions require re-flashing the firmware. For example, if a server is running AMI BMC firmware, it must be updated to OpenBMC firmware via a firmware flash, and vice versa. This method requires the firmware to support cross-solution updates (e.g., AMI→OpenBMC or OpenBMC→AMI). However, due to the architectural differences between firmware solutions, the areas and methods for storing user configurations also differ.

As a result, user configurations cannot be retained when updating between different firmware solutions. For example, if a user was using AMI BMC firmware and has added several users or modified network-related configurations, these settings will be lost when updating to OpenBMC firmware. After the update, the firmware would revert to OpenBMC's factory settings, requiring the user to reconfigure the necessary settings from scratch.

### SUMMARY

In an exemplary embodiment, a method for firmware update is provided. The method includes generating a configuration backup corresponding to configurations of first firmware that is currently running on a system; updating the system from the first firmware to second firmware; configuring the second firmware based on the configuration backup; and operating the system using the second firmware.

In a further exemplary embodiment, a system is provided. The system includes a memory comprising first memory space for storing firmware and second memory space for storing a configuration backup; and a control device, independent of a main processor of the system, wherein the control device operates with the firmware stored in the memory. The control device is configured to generate a first configuration backup corresponding to configurations of first firmware that is currently running on the system; update the system from the first firmware to second firmware; configure the second firmware based on the first configuration backup; and operate the system using the second firmware.

In yet a further exemplary embodiment, a non-transitory computer-readable medium is provided. The non-transitory computer-readable medium has stored thereon a set of instructions. The set of instructions, which if performed by one or more processors, cause the one or more processors to generate a first configuration backup corresponding to configurations of first firmware that is currently running on the system; update the system from the first firmware to second firmware; configure the second firmware based on the first configuration backup; and operate the system using the second firmware.

### BRIEF DESCRIPTION OF THE DRAWINGS

Systems and methods for firmware update are described in detail below with reference to the attached drawing figures, wherein:

FIG. 1A illustrates a block diagram of a system according to one or more embodiments of the present disclosure.

FIG. 1B is a block diagram illustrating a management scheme of a system according to one or more embodiments of the present disclosure.

FIG. 2 illustrates an example of different firmware architectures according to one or more embodiments of the present disclosure.

FIG. 3 illustrates a method for updating firmware according to one or more embodiments of the present disclosure.

FIG. 4 illustrates a template for storing a configuration backup according to one or more embodiments of the present disclosure.

FIG. 5 is a block diagram illustrating a communication environment according to one or more embodiments.

### DETAILED DESCRIPTION

The following detailed description is merely exemplary in nature and is not intended to limit the disclosure or the application and uses of disclosed embodiments and methods. Furthermore, there is no intention to be bound by any expressed or implied theory presented in the preceding background, summary, brief description of the drawings or the description that follows.

Systems and methods are disclosed herein that relate to preserving user configurations while performing system updating, such as updating firmware solutions. In certain embodiments, the systems and methods preserve the configuration of the current firmware and use the preserved configurations to configure the new firmware.

In certain embodiments, the systems and methods can be applied to firmware updates across different firmware solutions. This approach can reduce the time and effort required for reconfiguration and maintain consistency across solutions.

In certain embodiments, the systems and methods can be applied to firmware updates within a particular firmware solution. In such embodiments, configurations are preserved, and configuration loss is avoided as a result of certain situations, such as partition changes.

In certain embodiments, the systems and methods provided herein can be used to standardize firmware settings across various firmware solutions for a controller (e.g., BMC), such as AMI, OpenBMC, InsydeBMC, and future firmware solutions. Controller firmware updates can be applied seamlessly across different solutions without the concern of user configurations being reset to default values, e.g., factory settings. Furthermore, this approach enhances the flexibility and reliability of firmware updates ensuring that user configurations are preserved when switching between different versions.

In certain embodiments, the systems and methods can also support a manual option, allowing users to choose whether they want to retain the current configuration, thereby offering flexibility.

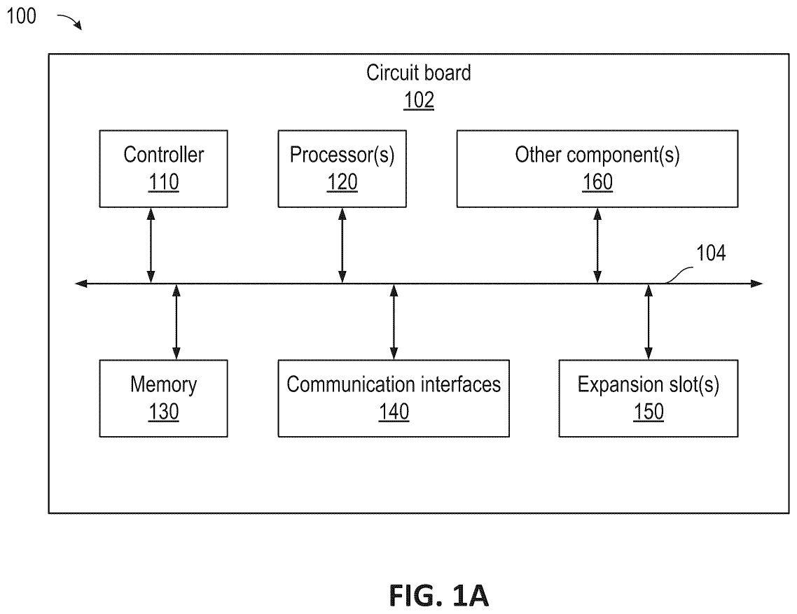

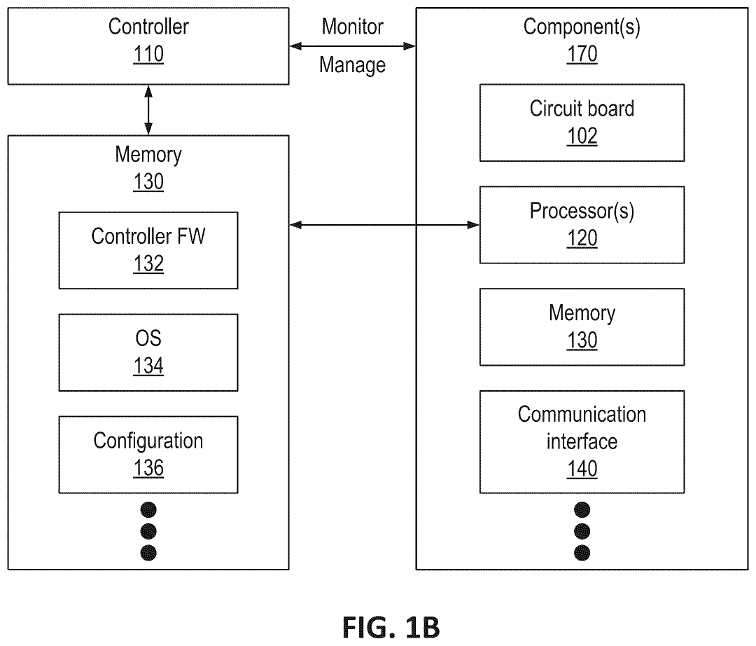

FIG. 1A illustrates a block diagram of a system 100, e.g., server, suitable for use in implementing embodiments of the present disclosure. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed components or devices, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the server system 100 falls within the scope and intent of the disclosed embodiments. The server system 100 can be housed in a rack-mounted chassis designed for optimal airflow and cooling, ensuring efficient heat dissipation during operation. Yet further, a person skilled in the art will recognize that the systems and methods described herein can be used with computer systems other than server systems.

The system 100 typically includes one or more circuit boards, e.g., a motherboard 102, that may carry various components, including hardware, firmware, and/or software, which may be integrated with, attached to, connected to, or in communication with the motherboard. As shown in FIG. 1A, the motherboard 102 carries at least one controller 110, such as a baseboard management controller (BMC), one or more processors 120, memory 130, communication interfaces 140, one or more expansion slots 150, and one or more other components 160. Such components and the circuit board 102 can communicate with one another through a bus 104, which may be integrated into the circuit board 102.

Processor(s) 120 may be configured to perform the operations in accordance with the instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor (e.g., a central processing unit (CPU) or graphics processing unit (GPU), respectively), digital signal processor, microcontroller, or the like. Memory 130 may be configured to store computer-readable instructions that, when executed by processor(s) 130, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), an electrical erasable programmable ROM (EEPROM), a flash memory, a dynamic random-access memory (“RAM”), and/or a static RAM. In certain embodiments, memory 130 may include multiple storage devices of various types.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10 G Ethernet adaptor, or the like. Wireless links can also be implemented by communication interfaces 140. In such an implementation, communication interfaces 140 can send and receive electrical, electromagnetic, or optical signals that carry digital data streams representing various types of information via a network. The network can typically include a cellular communication network, a Wireless Local Area Network (“WLAN”), a Wide Area Network (“WAN”), or the like.

Controller 110, e.g., BMC, may include a processing unit, associated memory, and communication interfaces, and is configured to monitor and manage the system's hardware components among other things. Controller 110 handles tasks such as remote system management, including hardware health monitoring, system event logging, and power control. Controller 110 can operate independently of the system's 100 main processor (e.g., processor(s) 120), allowing for out-of-band management. Controller 110 may in certain embodiments facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, and more.

FIG. 1B is a block diagram illustrating a management scheme of a system 100, according to one or more embodiments of the present disclosure.

As shown in FIG. 1B, controller 110 is configured to monitor and/or manage one or more components 170 in the system 100. In certain embodiments, some or all of the components 170 in the system 100 can be referred to as field-replace units (FRUs). The components 170 may include one or more components as illustrated in FIG. 1A, such as circuit board 102, processor(s) 120, memory 130, communication interfaces 140, components connected to the circuit board 102 through the extension slots 150, and/or other components 160. Each component 170 is associated with predefined information (e.g., to describe or record the status of the respective component 170), such as part numbers, serial numbers, manufacturing details, and other system-specific metadata. In certain embodiments, the predefined information of component 170 is defined in a data file, such as an FRU bin file. In certain embodiments, in an FRU device, the FRU bin file is stored in memory, which in certain embodiments is a EEPROM chip integrated within the device. The EEPROM serves as non-volatile memory that retains the stored information even when the device is powered off. In other embodiments, the FRU bin file may be stored in other types of memory.

Controller 110, e.g., BMC, is configured to perform processes that implement the functions discussed herein. For example, a processing unit in controller 110 may execute instructions stored in memory 130 to facilitate certain functions. The instructions stored in memory 130 may include various forms, such as firmware and/or software.

Memory 130 may store various types of information in designated areas. In certain embodiments, memory 130 may include a first area for storing controller firmware 132. Firmware (FW) refers to the software or operating system running on a specific chip. For example, controller firmware refers to the software or operating system running on controller 110. Additionally, memory 130 may include a second area for storing the operating system (OS) 134 that runs on the system's 100 main processor(s) 120. Furthermore, memory 130 may include a third area for storing configuration data 136 associated with the controller firmware. For example, the configuration data 136 may include user-specific configurations, such as account information or preferences, as well as technical settings of the controller firmware, including operational parameters, communication protocols, and device-specific preferences. Memory 130 may also include other areas for storing various types of data, such as system logs, operational data, temporarily data for real-time tasks, and more.

Processor(s) 120 may execute the OS 134 stored in memory 130 to perform various functions. In certain embodiments, controller 110 may interact with processor(s) 120 through communication interfaces and/or protocols supported by both the controller firmware 132 and the OS 134 of the processor(s) 120. Additionally, controller 110 can utilize various protocols and programs, such as Intelligent Platform Management Interface (IPMI) and Redfish, for managing and monitoring hardware.

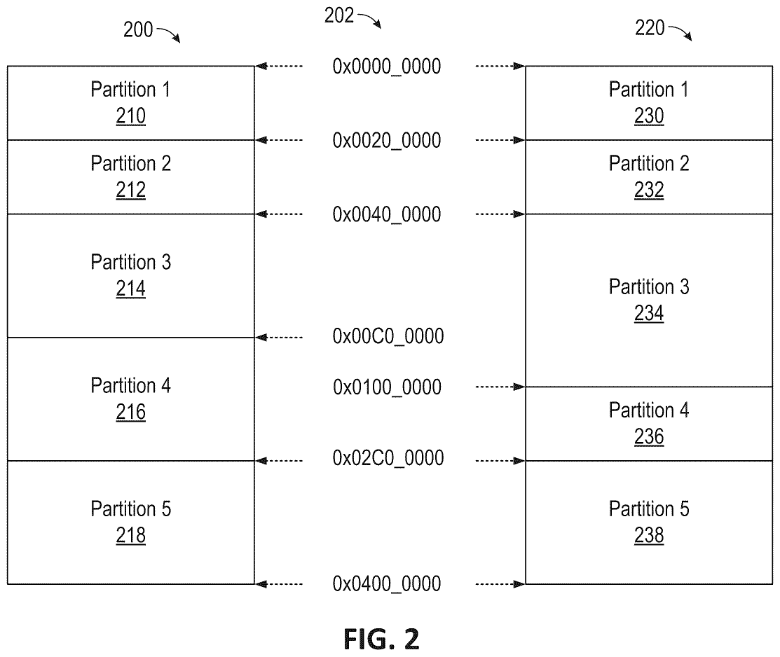

FIG. 2 illustrates an example of different firmware architectures according to one or more embodiments of the present disclosure. In the example, a first firmware architecture 200 and a second firmware architecture 220, as for example are stored in memory partitions, are compared side by side. It will be appreciated by those skilled in the art that, for some embodiments, controller 110 can utilize and/or execute various types of firmware or firmware architectures.

Each firmware architecture may include a plurality of partitions designated for storing different types of information. In this example, the first firmware architecture 200 may include partition 1 (210), partition 2 (212), partition 3 (214), partition 4 (216), and partition 5 (218). The second firmware architecture 220 may include partition 1 (230), partition 2 (232), partition 3 (234), partition 4 (236), and partition 5 (238). Each partition may be defined by a range of memory addresses. For example, as shown in FIG. 2, memory addresses for the partitions may be represented in hexadecimal (base 16) format.

In certain embodiments, the first firmware architecture 200 and the second firmware architecture 220 may include similar data structures but with different memory partitions. For example, partition 1 210 of the first firmware architecture 200 and partition 1 230 of the second firmware architecture 220 may be designated for storing Universal Boot Loader (U-boot), partition 2 (212) of the first firmware architecture 200 and partition 2 (232) of the second firmware architecture 220 may be designated for storing U-boot parameters, partition 3 (214) of the first firmware architecture 200 and partition 3 (234) of the second firmware architecture 220 may be designated for storing kernels, partition 4 (216) of the first firmware architecture 200 and partition 4 (236) of the second firmware architecture 220 may be designated for storing the file system, and partition 5 (218) of the first firmware architecture 200 and partition 5 (238) of the second firmware architecture 220 may be designated for storing specific Application Programming Interfaces (APIs), such as Redfish implemented with web-based communication.

In certain embodiments, one or more partitions may be defined with different memory address ranges in different firmware architectures. For example, partition 3 (234) of the second firmware architecture 220 may include more memory space than partition 3 (214) of the first firmware architecture 200. Partition 4 (236) of the second firmware architecture 220 may include less memory space than partition 4 (216) of the first firmware architecture 200.

It will be appreciated by those skilled in the art that, for some embodiments, different firmware architectures may include the same or different numbers of partitions, defined to store the same or different data, and defined with the same or different sizes (e.g., memory address ranges).

In an example, controller 110 is updated from the first firmware architecture 200 to the second firmware architecture 220. In the example, partition 3 (214) of the first firmware architecture 200 and partition 3 (234) of the second firmware architecture 220 are each designated for storing kernels. As shown in FIG. 2, the first firmware architecture 200 and the second firmware architecture 220 are defined with different partitions for storing kernels. In this case, a firmware change may involve importing new modules into the kernels. Using conventional technologies, the firmware update will not be able to preserve the configuration because the original partition memory locations have changed. For example, data in partition 3 (234) of the second firmware architecture 220 will overwrite a portion of data in partition 4 (216) of the first hardware architecture 200. The new firmware will overwrite the old configuration location and cannot retain it. Systems and methods of the present disclosure address such issues.

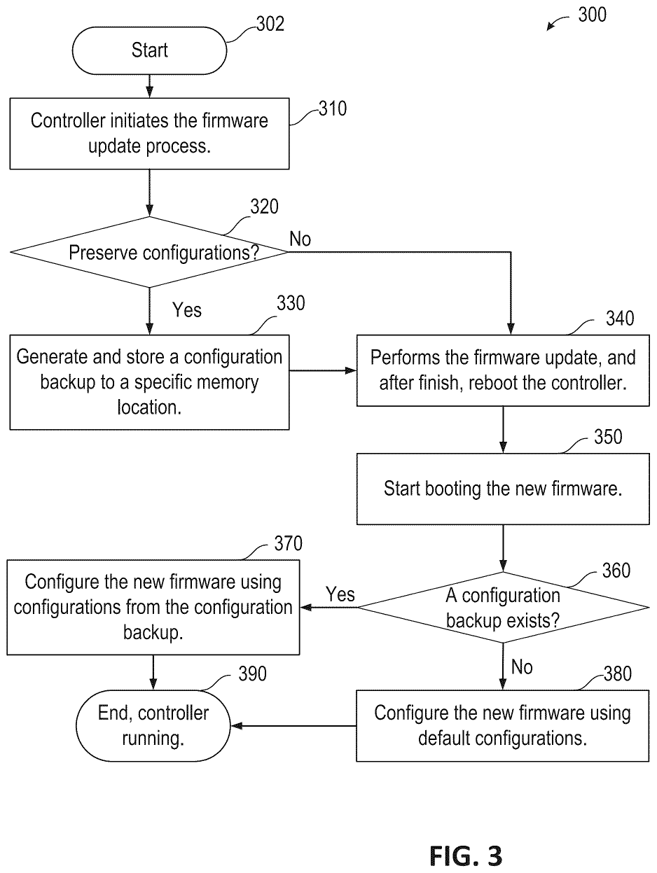

FIG. 3 illustrates a method 300 for updating firmware according to one or more embodiments of the present disclosure. Method 300 may be performed by controller 110 as illustrated in FIGS. 1A and 1B or other suitable control devices. Method 300 may be performed alone or in combination with other processes in the present disclosure. It will be recognized that method 300 may be performed in any suitable environment and in any suitable order except where otherwise apparent. Alternative steps may be performed instead of or in addition to those shown, and some steps may be omitted entirely. In certain embodiments, controller 110 can be implemented as a BMC. Memory 130 may include a first area to store controller firmware 132 and a second area to store configuration data 136, as shown in FIG. 1B. In this example, the controller firmware is referred to as the firmware.

At stage 302, controller 110 starts performing method 300. For example, controller 110 may receive instructions to update the firmware, for example, through user input or an automatic system update. Additionally, and/or alternatively, at stage 310, controller 110 initiates the firmware update process.

At stage 320, controller 110 determines whether to preserve configurations of the current firmware. For example, controller 110 may determine whether to preserve current firmware configurations based on user input. Additionally, and/or alternatively, controller 110 may base the decision on information related to the update. For example, if the update involves changes to firmware architecture and/or may overwrite certain data, controller 110 may decide to preserve the current firmware configurations. It will be recognized that controller 110 may make the decision at this stage based on other suitable conditions.

At stage 330, when preserving current firmware configurations, controller 110 generates and stores a configuration backup to a memory location. For example, controller 110 may store the configuration backup in the area of memory 130 designated for storing configuration data 136. In certain embodiments, configuration data 136 is stored in a memory space within the memory 130, which retains the stored data when controller 110 reboots. The memory space for storing configuration data 136 may be either non-volatile or volatile. For example, if controller 110 is a BMC, configuration data 136 may be stored in a volatile memory, such as Video Graphics Array (VGA) RAM (VRAM), with the BMC configured to preserve certain data in the volatile memory to be preserved during the BMC's reboot.

In certain embodiments, controller 110 generates the configuration backup based on a unified format, allowing the configuration backup to be used across various firmware solutions.

At stage 340, controller 110 performs the firmware update and, upon completion, reboots. As shown in FIG. 3, controller 110 may proceed to this stage from stage 320, if controller 110 determines not to preserve current firmware configurations. Alternatively, controller 110 may proceed to this stage from stage 330 after storing the configuration backup in the specific memory location.

At stage 350, controller 110 starts booting the new firmware. This stage may include configuration of various parameters and/or settings in the new firmware.

At stage 360, controller 110 determines whether a configuration backup exists. Controller 110 may check a specific memory location (e.g., a predefined area for storing configuration data 136 within memory 130). If detecting the configuration backup in the specific memory location, controller 110 may retrieve the configuration backup.

At stage 370, when controller 110 detects a configuration backup, controller 110 configures the new firmware using configurations from the configuration backup. In certain embodiments, controller 110 may extract previous firmware configurations, for example, by parsing the configuration backup according to its template/format. In certain embodiments, controller 110 may run a service (e.g., a program) to process the configuration backup. For example, the service may be implemented as a program including one or more functions defined to extract information corresponding to different features of the firmware.

At stage 380, when controller 110 does not detect a configuration backup, controller 110 configures the new firmware using default configurations, e.g., factory settings or including other defined default values.

At stage 390, controller 110 completes the firmware update process and continues operating with the new firmware.

In certain embodiments, when saving and restoring configurations (e.g., at stages 330, 360, and/or 370), controller 110 may utilize encryption and verification mechanisms to ensure the security and integrity of the configuration files (e.g., the configuration backup).

In certain embodiments, method 300 can be integrated with automation tools, enabling system 100 to automatically manage and back up the firmware configurations, thereby further improving operational efficiency.

As mentioned earlier, at stage 330, controller 110 may generate the configuration backup based on a format/template that can be used across various firmware solutions. For example, JavaScript Object Notation (JSON) Schema may be used to generate a configuration backup in the form of JSON data. JSON Schema is a declarative language that allows user to define the structure, content, and constraints of JSON data.

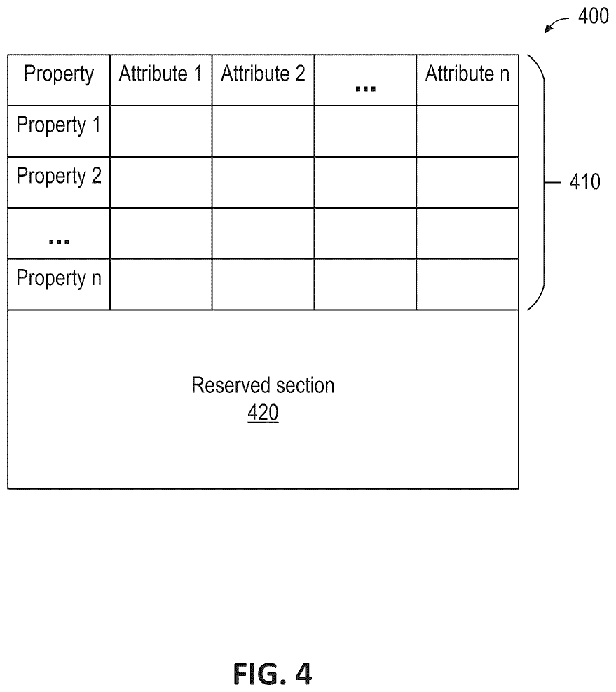

FIG. 4 illustrates a template 400 for storing the configuration backup according to one or more embodiments of the present disclosure. In this example, template 400 includes a plurality of parameters/settings associated with firmware solutions and their corresponding attributes (e.g., property names/identifications, values, types, descriptions, etc.). FIG. 4 shows template 400 in a table. However, it will be recognized that the configuration backup can be stored in any suitable type of data structure, and the number and order of parameters/settings, as well as their attributes, can vary.

As shown in FIG. 4, template 400 may be defined with various sections, including a predefined section 410 and a reserved section 420. The predefined section 410 includes one or more predefined properties. The reserved section 420 provides space for defining additional properties for future expansion. When generating the configuration backup, controller 110 may query properties in the current firmware based on those listed in template 400 and extract available attributes for the identified properties. In certain embodiments, controller 110 may leave certain entries blank or set them to a predefined value if the data is unavailable. In certain embodiments, controller 110 stores user-specific configurations in the configuration backup using template 400.

Table 1 lists some commonly used user settings that are frequently changed according to one or more embodiments of the present disclosure.

TABLE 1
List of commonly used user settings that are frequently changed.

| Property | Type | Description |
|---|---|---|
| UserAccount [{ | object | User account matrix |
| Index | int | User index |
| Username | string | User name |
| Password | string | User password |
| RoleId | string | User permissions (e.g., Admin, operator, user, or none) |
| }] | | |
| EthernetInterfaces [{ | array | Network interface matrix |
| Index | int | Network index |
| InterfaceEnabled | boolean | Network on or off |
| AddressOrigin | string | IP source, DHCP/Static |
| IPv4SAddresses [ { | array | Network IPV4 setup |
| Address | string | IPV4 address, DHCP not referenced |
| Gateway | string | IPV4 Getaway settings, DHCP not referenced |
| SubnetMask | string | IPV4 subnet mask, DHCP not referenced |
| } ] | | |
| IPv6Addresses [ { | array | Network IPV6 settings |
| Address | string | IPV6 address, DHCP not referenced |
| PrefixLength | string | IPV6 prefix length, DHCP not referenced |
| } ] | | |
| MACAddress | string | Network interface MAC address |
| VLANs { | object | VLAN object configuration |
| VLANEnable | boolean | VALN on or off |
| VLANId | int | VLAN ID |
| } | | |
| } | | |
| ThermalControl { | object | Network interface Cooling settings control |
| PlatformID | string | Platform ID |
| Mode | string | Set to automatic control or manual control |
| FanSpeedControl [ | arry | Fan speed matrix |
| Index | int | Fan index |
| DutyCycle | int | If in manual mode, refer to this Duty Cycle setting |
| ] | | |
| }] | | |
| ServicePort { | | |
| SSH | int | SSH port Number |
| IPMI | int | IPMI port Number |
| KVM | int | KVM port Number |
| Vmedia | int | Vmedia port Number |
| } | | |
| ... | | . . . |
| (can add/modify according | | (can add/modify e.g., port |
| to future requirements) | | number, according to future |
| | | requirements) |

Template 400 may include some or all of the properties as shown in Table 1, along with additional properties as needed. In certain embodiments, the plurality of parameters/settings may be grouped corresponding to their functions/features in firmware solutions. For example, as shown in Table 1, the property of UserAccount may include several sets of user account information, each of which may be associated with an index, a user name, a password, and/or a role identification (RoleID).

In certain embodiments, at stage 330, controller 110 may generate the configuration backup based on template 400 and/or information specified in Table 1. For example, controller 110 may generate a JSON data file following the predefined template/format and store the generated file in the specific memory location.

The following is an example code for preserving certain properties as listed in Table 1. In the example, configurations of user accounts, ethernet interfaces, thermal control, and service ports are preserved based on information from the current firmware. The code preserves configurations of three distinct user accounts, two ethernet interfaces, seven thermal control settings, and four service ports.

Example code for preserving a plurality of properties. Copyright © 2024 Aivres

```
“UserAccount”: [
    {
      “Index”: “1”,
      “Username”: “root”,
      “Password”:
“$y$j9T$mxlTDGwszlqhzl0LfeX8E1$gMlCf22zl31nX1heAq.zyHulw4d1PlouULV6rZnULd2”,
      “RoleId”: “Administrator”,
    },
    {
      “Index”: “2”,
      “Username”: “AddUser1”,
      “Password”: “$KiekJ932-
KJiefiadlkj9300.fekdiek0Kin9nKKKd1nX1kein9Jin24JKueqJi90L0jd423”,
      “RoleId”: “Administrator”,
    },
    {
      “Index”: “3”,
      “Username”: “AddUser2”,
      “Password”:
“$Mn83oHipaq0xnz98kjh982ja8hH98fa93bn9nu8o28nvcn8Ujhsb745hHGl83hs8kkbx6syx”,
      “RoleId”: “Administrator”,
    },
],
“EthernetInterfaces”: [
    {
      “Index”: “0”,
      “InterfaceEnabled”: “true”,
      “AddressOrigin”: “DCHP”,
      “IPv4SAddresses”: [
        {
          “Address”: “”,
          “Gateway”: “”,
          “SubnetMask”: “”,
        },
      ],
      “IPv6Addresses”: [
        {
          “Address”: “”,
          “PrefixLength”: “”,
        },
      ],
      “MACAddress”: “E0:AF:03:9A:68:B0”,
      “VLANs”: {
        “VLANEnable”: “fales”,
        “VLANId”: “0”
      },
    },
    {
      “Index”: “1”,
      “InterfaceEnabled”: “true”,
      “AddressOrigin”: “Static”,
      “IPv4SAddresses”: [
        {
          “Address”: “192.168.100.123”,
          “Gateway”: “192.168.100.254”,
          “SubnetMask”: “255.255.255.0”,
        },
      ],
      “IPv6Addresses”: [
        {
          “Address”: “fe80::7ac8:9dd4:2dd0:5e3c”,
          “PrefixLength”: “17”,
        },
      ],
      “MACAddress”: “E0:AF:03:9A:68:B1”,
      “VLANs”: {
        “VLANEnable”: “true”,
        “VLANId”: “777”
      },
    },
},
“ThermalControl”: {
    “PlatformID”: “NF5820m7 24HDD”,
    “Mode”: “Manual”,
    “FanSpeedControl”: [
      {
        “Index”: “0”,
        “DutyCycle”: “20”,
      },
      {
        “Index”: “1”,
        “DutyCycle”: “50”,
      },
      {
        “Index”: “2”,
        “DutyCycle”: “30”,
      },
      {
        “Index”: “4”,
        “DutyCycle”: “30”,
      },
      {
        “Index”: “5”,
        “DutyCycle”: “50”,
      },
      {
        “Index”: “6”,
        “DutyCycle”: “20”,
      },
    ],
},
“ServicePort”: {
    “SSH”: “9922”,
    “IPMI”: “623”,
    “KVM”: “56670”,
    “Vmedia”: “20202”,
}
  }
```

Then, at stage 360, when detecting the existence of a configuration backup, controller 110 may retrieve the configuration backup and decode it (e.g., parse it) to extract the preserved configurations from the previous firmware. Subsequently, at stage 370, controller 110 may use the preserved configurations to configure the new firmware. This ensures that the previous configurations, such as user-specific settings, remain consistent after the firmware update.

In certain embodiments, controller 110 may process the configuration backup, e.g., a JSON file, in several stages. For example, in the first stage, controller 110 may parse the JSON file; in the second stage, controller 110 may call the corresponding setting functions based on the parsed content; and in the third stage, controller 110 may encapsulate the setting functions into a library for future replacement. In certain embodiments, each property group-such as user account settings, ethernet settings, thermal control settings, or server port settings—may be encapsulated into a single library.

In certain embodiments, controller 110 may utilize a library to process the configuration backup, including performing the aforementioned three stages to extract the preserved configurations. At stage 370, upon detecting the existence of the configuration backup (at stage 360), controller 110 may execute the library. This approach facilitates easy maintenance and updates across different platforms. For example, whether it's AMI BMC, OpenBMC, or future firmware solutions, the library enables unified configuration loading and management, thereby providing cross-platform compatibility and flexibility.

The following is an example of creating a library named “ConfigLoader” for processing the configuration backup for BMC.

A header file, “BMCConfigLib.h,” is defined as follows:

Example code for defining the header file: BMCConfigLib.h.
Copyright © 2024 Aivres

```
#ifndef BMCCONFIGLIB_H
#define BMCCONFIGLIB_H
#include <string>
#include <nlohmann/json.hpp>
class BMCConfigLib {
public:
  static void ApplyUserAccountSettings(const nlohmann::json& userAccount);
  static void ApplyEthernetSettings(const nlohmann::json& ethernetInterfaces);
  static void ApplyThermalSettings(const nlohmann::json& thermalControl);
  static void ApplyServicePortSettings(const nlohmann::json& servicePort);
};
#endif // BMCCONFIGLIB_H
```

The implementation file, “BMCConfigLib.cpp,” for the setting functions is defined as follows:

Example code for defining the implementation file: BMCConfigLib.cpp.
Copyright © 2024 Aivres

```
#include “BMCConfigLib.h”
#include <iostream>
void BMCConfigLib::ApplyUserAccountSettings(const nlohmann::json& userAccount) {
  for (const auto& user : userAccount) {
    std::string username = user[“Username”];
    std::string password = user[“Password”];
    std::string roleId = user[“RoleId”];
    // Apply user account settings to BMC firmware
    std::cout << “Setting User Account: ” << username << “, Role: ” << roleId << std::endl;
  }
}
void BMCConfigLib::ApplyEthernetSettings(const nlohmann::json& ethernetInterfaces) {
  for (const auto& interface : ethernetInterfaces) {
    int index = interface[“Index”];
    bool enabled = interface[“InterfaceEnabled”];
    std::string addressOrigin = interface[“AddressOrigin”];
    std::string macAddress = interface[“MACAddress”];
    // Apply ethernet settings to BMC firmware
    std::cout << “Setting Ethernet Interface: ” << index << “, Enabled: ” << enabled << std::endl;
  }
}
void BMCConfigLib::ApplyThermalSettings(const nlohmann::json& thermalControl) {
  std::string platformId = thermalControl[“PlatformID”];
  std::string mode = thermalControl[“Mode”];
  for (const auto& fan : thermalControl[“FanSpeedControl”]) {
    int index = fan[“Index”];
    int dutyCycle = fan[“DutyCycle”];
    // Apply thermal control settings to BMC firmware
    std::cout << “Setting Fan: ” << index << “, DutyCycle: ” << dutyCycle << std::endl;
  }
}
void BMCConfigLib::ApplyServicePortSettings(const nlohmann::json& servicePort) {
  int sshPort = servicePort[“SSH”];
  int ipmiPort = servicePort[“IPMI”];
  int kvmPort = servicePort[“KVM”];
  int vmediaPort = servicePort[“Vmedia”];
  // Apply service port settings to BMC firmware
  std::cout << “Setting Service Ports - SSH: ” << sshPort << “, IPMI: ” << ipmiPort << std::endl;
  }
```

The Main function of ConfigLoader is defined as follows:

Example code for defining the Main function. Copyright © 2024 Aivres

```
#include <iostream>
#include <fstream>
#include <nlohmann/json.hpp>
#include “BMCConfigLib.h”
using json = nlohmann::json;
int main( ) {
    // Read the JSON file
    std::ifstream configFile(“PreserveConfig.json”);
    if (!configFile) {
      std::cerr << “Unable to open config file” << std::endl;
      return 1;
    }
    json config;
    configFile >> config;
    // Apply settings from JSON
    if (config.contains(“UserAccount”)) {
      BMCConfigLib::ApplyUserAccountSettings(config[“UserAccount”]);
    }
    if (config.contains(“EthernetInterfaces”)) {
      BMCConfigLib::ApplyEthernetSettings(config[“EthernetInterfaces”]);
    }
  if (config.contains(“ThermalControl”)) {
      BMCConfigLib::ApplyThermalSettings(config[“ThermalControl”]);
    }
    if (config.contains(“ServicePort”)) {
      BMCConfigLib::ApplyServicePortSettings(config[“ServicePort”]);
    }
    return 0;
  }
```

The above provides example code for the tool, ConfigLoader. Below is an example of creating a recipe using the OpenBMC architecture. First, an example of the directory structure is:

Example directory structure: Copyright © 2024 Aivres

| meta-custom/ | | |
|---|---|---|
| ├ | recipes-bmc/ | |
| \| | ├ | bmc-config-loader/ |
| \| | \| | ├ bmc-config-loader_1.0.bb |
| \| | \| | ├ BMCConfigLib.h |
| \| | \| | ├ BMCConfigLib.cpp |
| \| | \| | ├ main.cpp |
| \| | \| | └ CMakeLists.txt |

Below is an example of scripting the bmc-config-loader_1.0.bb recipe file for OpenBMC:

Example code for bmc-config-loader_1.0.bb: Copyright © 2024 Aivres

```
SUMMARY = “BMC Configuration Loader”
DESCRIPTION = “A tool to load and apply BMC configurations from a JSON file”
SECTION = “utils”
LICENSE = “MIT”
LIC_FILES_CHKSUM = “file://LICENSE;md5 =<LICENSE_FILE_MD5>”
SRC_URI = “file://BMCConfigLib.h \
    file://BMCConfigLib.cpp \
    file://main.cpp \
    file://CMakeLists.txt”
S = “${WORKDIR}”
inherit cmake
do_install( ) {
  install -d ${D}${bindir}
  install -m 0755 ${B}/bmc-config-loader ${D}${bindir}/bmc-config-loader
}
```

Below is an example code for updating the CMakeLists.txt file:

Example code for updating CMakeLists.txt file: Copyright © 2024 Aivres

cmake_minimum_required(VERSION 3.10)
project(BMCConfigLoader)
set(CMAKE_CXX_STANDARD 17)
find_package(nlohmann_json REQUIRED)
add_library(BMCConfigLib STATIC BMCConfigLib.cpp)
target_include_directories(BMCConfigLib PUBLIC ${CMAKE_CURRENT_SOURCE_DIR})
target_link_libraries(BMCConfigLib PUBLIC nlohmann_json::nlohmann_json)
add_executable(bmc-config-loader main.cpp)
target_link_libraries(bmc-config-loader PRIVATE BMCConfigLib)

Finally, ConfigLoader can be integrated into the build environment and compiled for use.

Example code for integrating ConfigLoader:
Copyright © 2024 Aivres

bitbake-layers add-layer /path/to/meta-custom
bitbake bmc-config-loader

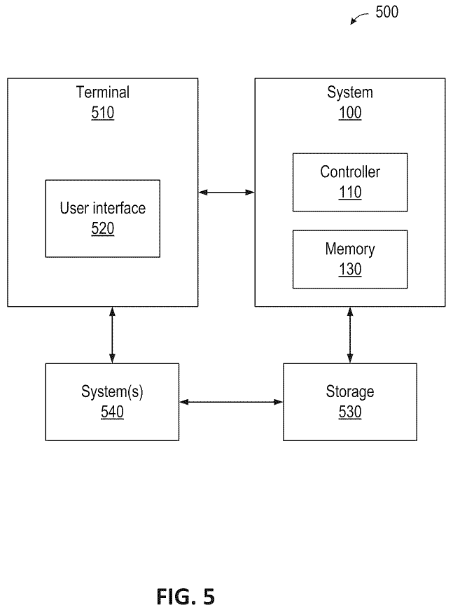

FIG. 5 is a block diagram illustrating a communication environment 500 according to one or more embodiments.

In certain embodiments, communication environment 500 may include system 100 and a terminal device 510. System 100 may be communicating with a terminal device, allowing user to access and/or monitor the operation of the system 100 through a user interface 520 implemented in terminal device 510. For example, the system 100 may be a server system, while the terminal device may be a personal computer (“PC”), a laptop computer, a mobile device, a smartphone, a tablet computer, a virtual reality headset, a video player, a video camera, a vehicle, a virtual machine, a drone, a robot, a handheld communications device, a vehicle computer system, an embedded system controller, a workstation, an edge device, any combination of these delineated devices, or any other suitable device.

In certain embodiments, user interface 520 may include various functions for monitoring and management. For example, user interface 520 may display the progress of firmware preservation and/or update (e.g., the progress of performing method 300). Additionally, user interface 520 may display the preserved configurations, such as in a format similar to template 400 (as depicted in FIG. 4) or Table 1. Furthermore, user interface 520 may provide functions that allow the user to modify predefined configurations for preservation. For example, the user may add, delete, and/or modify certain properties and/or their corresponding attributes in template 400 or Table 1.

In certain embodiments, communication environment 500 may further include storage 530 and one or more systems 540. Storage 530 may include various types of memory similar to those of memory 130. System(s) 540 may include the same or similar components as system 100, such as controller 110 and memory 130. In certain embodiments, the preserved configurations of system 100 may be used to configure firmware (e.g., controller firmware) in system(s) 540. For example, system 100 (e.g., controller 110) may send the preserved configurations from memory 130 to storage 530. Then, system(s) 540 (e.g., their controller(s)) may receive the preserved configurations from storage 530 and use these configurations to configure the firmware of system(s) 540. In certain embodiments, system(s) 540 may receive instructions from terminal 510 to perform a firmware update and/or configure firmware using specific configurations.

It is noted that the techniques described herein may be embodied in executable instructions stored in a non-transitory computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic formats. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. The elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method for firmware update, comprising:
generating a configuration backup corresponding to configurations of first firmware that is currently running on a system;
updating the system from the first firmware to second firmware;
configuring the second firmware based on the configuration backup; and
operating the system using the second firmware.

2. The method of claim 1, further comprising:
storing the configuration backup in first memory space;
after updating the system from the first firmware to the second firmware, checking the first memory space for the configuration backup; and
based on detecting the configuration backup in the first memory space, retrieving the configuration backup from the first memory space.

3. The method of claim 1, wherein the configuration backup comprises a plurality of properties and corresponding attributes associated with the configurations of the first firmware, and the method further comprises:
parsing the configuration backup to extract the plurality of properties and the corresponding attributes,
wherein configuring the second firmware is based on the plurality of properties and the corresponding attributes extracted from the first firmware.

4. The method of claim 3, wherein the configuration backup is generated based on a unified template, wherein the template is predefined with the plurality of properties and corresponding attributes to be stored.

5. The method of claim 1, further comprising:
generating a second configuration backup corresponding to configurations of the second firmware; and
storing the second configuration backup in the first memory space.

6. The method of claim 1, wherein the first firmware and the second firmware are different firmware solutions.

7. The method of claim 1, wherein the first firmware and the second firmware are different versions of the same firmware solution.

8. The method of claim 1, wherein the configuration backup is implemented with encryption and verification mechanisms during the saving and restoring of configurations.

9. The method of claim 1, further comprising:
configuring, on a second system, third firmware based on the configuration backup; and
operating the second system using the third firmware.

10. The method of claim 1, wherein the first firmware and the second firmware are operating systems running on a control device of the system, wherein the control device operates independently of a main processor of the system.

11. A system, comprising:
a memory comprising first memory space for storing firmware and second memory space for storing a configuration backup; and
a control device, independent of a main processor of the system, wherein the control device operates with the firmware stored in the memory,
wherein the control device is configured to:
generate a first configuration backup corresponding to configurations of first firmware that is currently running on the system;
update the system from the first firmware to second firmware;
configure the second firmware based on the first configuration backup; and
operate the system using the second firmware.

12. The system of claim 11, wherein the control device is configured to:
store the configuration backup in first memory space;
after updating the system from the first firmware to the second firmware, check the first memory space for the configuration backup; and
based on detecting the configuration backup in the first memory space, retrieve the configuration backup from the first memory space.

13. The system of claim 11, wherein the configuration backup comprises a plurality of properties and corresponding attributes associated with the configurations of the first firmware, and wherein the control device is configured to:
parse the configuration backup to extract the plurality of properties and the corresponding attributes,
wherein configuring the second firmware is based on the plurality of properties and the corresponding attributes extracted from the first firmware.

14. The system of claim 13, wherein the configuration backup is generated based on a unified template, wherein the template is predefined with the plurality of properties and corresponding attributes to be stored.

15. The system of claim 11, wherein the control device is configured to:
generate a second configuration backup corresponding to configurations of the second firmware; and
store the second configuration backup in the first memory space.

16. The system of claim 11, wherein the first firmware and the second firmware are different firmware solutions.

17. The system of claim 11, wherein the first firmware and the second firmware are different versions of the same firmware solution.

18. The system of claim 1, wherein the configuration backup is implemented with encryption and verification mechanisms during the saving and restoring of configurations.

19. The system of claim 1, wherein the control device is configured to:
configure, on a second system, third firmware based on the configuration backup; and
operating the second system using the third firmware.

20. A non-transitory computer-readable medium having stored thereon a set of instructions, which if performed by one or more processors, cause the one or more processors to:
generate a configuration backup corresponding to configurations of first firmware that is currently running on a system;
update the system from the first firmware to second firmware;
configure the second firmware based on the configuration backup; and
operate the system using the second firmware.
